(19) United States
(12) Patent Application Publication
(10) Pub. No.: US 2023/0147908 A1
(43) Pub. Date: May 11, 2023

(54) SILICONE RUBBER COMPOSITION

(71) Applicant: DOW SILICONES CORPORATION, Midland, MI (US)

(72) Inventors: Robert A. DRAKE, Barry (GB); Beatriz C. MA, Wiesbaden (DE); Hans Peter WOLF, Liederbach (DE); Elizabeth M. SANTOS, Midland, MI (US)

(21) Appl. No.: 17/912,829

(22) PCT Filed: Mar. 23, 2021
(86) PCT No.: PCT/US2021/023614

§ 371 Date: Sep. 19, 2022

Related U.S. Application Data
(60) Provisional application No. 62/994,298, filed on Mar. 25, 2020.

(51) Int. Cl. C08G 77/20; C08G 77/12; C08G 77/08; C08K 9/06; C08J 3/20; H01B 3/46

(52) U.S. Cl. CPC C08G 77/20; C08G 77/12; C08G 77/08; C08K 9/06; C08J 3/203; H01B 3/46; C08K 2201/001; C08J 2383/07; C08J 2383/05

(57) ABSTRACT

A curable silicone elastomer composition is disclosed. The composition comprises one or more non-fluorinated polydiorganosiloxane polymers and silica filler. The silica filler is at least partially treated with a fluorinated hydrophobing treating agent. Also provided is a method of making the composition and its use in the manufacture of insulators for high voltage applications, especially high voltage direct current (HVDC) applications and accessories such as cable joints, cable terminal applications, and connectors. The fluorinated hydrophobing treating agents are selected from one or more silanol terminated fluorinated siloxane oligomer(s) having from 2 to 20 siloxane units, and/or one or more fluorinated silane diol(s), and/or one or more fluorinated trialkoxy silane(s), and/or one or more fluorinated silazane(s), or a mixture thereof.

The present disclosure relates to a silicone based composition comprising one or more non-fluorinated polydiorganosiloxane polymers and silica filler, which silica filler is at least partially treated with a fluorinated hydrophobing treating agent, a method of making same and its use in the manufacture of insulators for high voltage applications, especially high voltage direct current (HVDC) applications and accessories such as cable joints, cable terminal applications, and connectors.

Whilst, in most instances, alternating current (AC) is preferred for the supply of electricity to end users, long distance power transmission for distances e.g. >1000 km, may be undertaken using high voltage direct current (HVDC) systems because it involves lower electrical loss and therefore can be less expensive. Long distance HVDC transmission is generally undertaken in three ways, overhead e.g. via pylons; through underground systems and where necessary via “submarine” systems for transportation under the sea etc. It is probably fair to say that underground systems are significantly more aesthetically pleasing to the general public than pylons as the latter, whilst practical, can be considered an eyesore. However, underground HVDC transmission is the most challenging for the supplier as it generally involves the use of multiple lengths of cable joined together through cable joints every 1 to 2 km compared to overhead and submarine systems. Hence, whilst cable joints are required for any sort of HVDC transmission, the requirement is particularly acute in the case of underground systems.

However, the insulating materials utilised with respect to AC current transmission systems are not always transferrable to direct current transmission systems because electrical stress is significantly different for AC and DC conditions, not least because the insulating material is exposed to a higher continuous electrical stress under DC conditions which can lead to a dielectric breakdown of materials. Dealing with such matters is becoming particularly important today given the HVDC voltage requirements for new cables and cable accessories keep increasing and can now be >500 kV or even >800 kV.

In the transmission of direct current, a power cable system has resistive electric field distribution characteristics, with the electric field distribution depending on volume resistivity. In contrast for joints to be used in high voltage alternating current applications it is important to minimise any difference in permittivity between the cable insulation and joint insulation to obtain the desired performance.

Hence, tor HVDC systems in e.g. joint boxes tor HVDC power cables the cable is surrounded by an inner layer of “cable insulation” which may be made from a suitable material such as cross-linked polyethylene (XLPE) and said cable insulation is surrounded by a layer of further insulation, typically referred to as “joint insulation” which is often provided in the form of ethylene propylene diene monomer rubber (EPDM) or a silicone rubber elastomeric material. In high voltage direct current applications therefore, it is important to minimise any difference in volume resistivity between the cable insulation and joint insulation in order to ensure the electric field is uniformly distributed at the interface between them in order to avoid e.g. dielectric breakdown. Hence, it is desired that the joint insulation and cable insulation materials are designed to have volume resistivity values as close to each other as possible.

Current approaches using a combination of crosslinked polyethylene (XLPE) as the cable insulation and silicone rubber based elastomeric materials as the joint insulation are seeing stability issues due to differences in their electrical properties. Typically, unmodified silicone rubber elastomeric materials are too insulating in comparison to XLPE under the same electrical field strength. The silicone rubber-based materials are excellent electrical insulators once cured into a final product, typically they have a volume resistivity of less than or equal to (≥) 10¹⁵ ohm-cm depending on sample preparation and measurement methods, but this is much greater than the typical volume resistivity of XLPE.

Historically, the industry solution has been the introduction of electrically conductive fillers (e.g. metal powder, metal flakes, carbon blacks or carbon nanotubes) or electrically semi-conductive fillers into the silicone rubber compositions to render the silicone rubber elastomeric materials produced therefrom sufficiently conductive to enable the distribution of local DC loadings through a marginally conductive silicone elastomeric product made from a conductive LSR composition providing a bulk resistivity in the range 10¹⁰ to 10¹⁵ ohm-cm or alternatively 10¹⁰ to 10¹⁴ ohm-cm.

However, whilst the use of these electrically conductive fillers and/or electrically semi-conductive fillers is able to solve the distribution of local DC loadings, the introduction of such fillers can create further issues, not least an inability to control and/or obtain uniform electrical properties within a silicone elastomer, worsening of physical properties and reduced dielectric strength.

It has recently been found that an elastomeric material made from compositions comprising a mixture of fluorinated polydiorganosiloxane polymer(s) and non-fluorinated polydiorganosiloxane polymer(s) prepared by mixing fluorinated polydiorganosiloxane polymer base(s) and non-fluorinated polydiorganosiloxane polymer base(s), wherein the respective bases comprise the polymer and a reinforcing filler, is able to provide an insulating material with a volume resistivity closer to that of the cross-linked polyethylene without the need for electrically conductive fillers or electrically semi-conductive fillers. However, the use of such a mixture, whilst a significant improvement on the use of compositions using only non-fluorinated polydiorganosiloxane polymers filled with electrically conductive fillers has potential disadvantages in that fluorinated polydiorganosiloxane polymers are significantly more expensive to produce, because physical properties of the resulting elastomers may deteriorate as the proportion by weight % (wt. %) of fluorinated polydiorganosiloxane polymers in the polymer, and because mixtures of fluorinated polydiorganosiloxane polymers and non-fluorinated polydiorganosiloxane polymers can phase separate and therefore may require compatiblising agents.

Hence, there remains a need to develop silicone rubber insulation materials capable of withstanding the high electrical stresses applied on cable insulation and cable joint insulation in high voltage direct current (HVDC) systems and high voltage alternating current (HVAC) systems. In the case of HVDC systems it is desirable to provide silicone-based insulators having electrical properties to match the range of XLPE volume resistivity values which could be advantageous for applications in high voltage direct current (HVDC) such as cables and cable joints.

It has now been determined that the need to utilise either elastomers comprising mixtures of fluorinated polydiorganosiloxane polymers and non-fluorinated polydiorganosiloxane polymers or silicone rubber compositions containing electrically conductive and/or electrically semi-conductive fillers can be avoided by using one or more non-fluorinated polydiorganosiloxane polymers with finely divided reinforcing silica filler which is at least partially treated with a fluorinated hydrophobing treating agent.

There is provided a curable silicone elastomer composition comprising:
(A) at least one non-fluorinated polydiorganosiloxane;
(B) at least one reinforcing silica filler which is at least partially hydrophobically treated with a fluorinated hydrophobing treating agent selected from
one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s) or a mixture thereof;
and at least one of (C) or (D) wherein
(C) is at least one organohydrogenpolysiloxane (C)(i), at least one hydrosilylation catalyst (C)(ii) and optionally at least one cure inhibitor (C)(iii); and
(D) is at least one peroxide catalyst.

There is also provided a use of curable silicone elastomer composition Comprising:
(A) at least one non-fluorinated polydiorganosiloxane;
(B) at least one reinforcing silica filler which is at least partially hydrophobically treated with a fluorinated hydrophobing treating agent selected from
one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s) or a mixture thereof;
and at least one of (C) or (D) wherein
(C) is at least one organohydrogenpolysiloxane (C)(i), at least one hydrosilylation catalyst (C)(ii) and optionally at least one cure inhibitor (C)(iii); and
(D) is at least one peroxide catalyst; in or as a high voltage direct current insulator.

There is also provided a high voltage direct current insulator comprising an elastomeric product of a curable silicone elastomer composition comprising
(A) at least one non-fluorinated polydiorganosiloxane;
(B) at least one reinforcing silica filler which is at least partially hydrophobically treated with a fluorinated hydrophobing treating agent selected from
one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s) or a mixture thereof;
and at least one of (C) or (D) wherein
(C) is at least one organohydrogenpolysiloxane (C)(i), at least one hydrosilylation catalyst (C)(ii) and optionally at least one cure inhibitor (C)(iii); and
(D) is at least one peroxide catalyst.

In a still further embodiment there is provided a high voltage direct current insulator comprising an elastomeric product obtained or obtainable by curing silicone elastomer composition comprising
(A) at least one non-fluorinated polydiorganosiloxane;
(B) at least one reinforcing silica filler which is at least partially hydrophobically treated with a fluorinated hydrophobing treating agent selected from
one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s) or a mixture thereof;
and at least one of (C) or (D) wherein
(C) is at least one organohydrogenpolysiloxane (C)(i), at least one hydrosilylation catalyst (C)(ii) and optionally at least one cure inhibitor (C)(iii); and
(D) is at least one peroxide catalyst.

There is also provided a method of preparing a curable silicone elastomer composition comprising:
(A) at least one non-fluorinated polydiorganosiloxane;
(B) at least one reinforcing silica filler which is at least partially hydrophobically treated with a fluorinated hydrophobing treating agent selected from
one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s) or a mixture thereof;
and at least one of (C) and optionally (D) wherein
(C) is a hydrosilylation cure package comprising at least one organohydrogenpolysiloxane (C)(i), at least one hydrosilylation catalyst (C)(ii) and optionally at least one cure inhibitor (C)(iii); and
(D) is least one peroxide catalyst; by
   (i) making a silicone base composition by mixing non-fluorinated polydiorganosiloxane (A) with at least one reinforcing silica filler and
   (ii) introducing components (C), or a mixture of component (C) and component (D) and storing the resulting composition; wherein when the composition contains hydrosilylation cure package (C) the composition is stored in two or more parts with components (C)(i) and (C) (ii) being kept in separate parts;
characterised in that the at least one reinforcing silica filler is at least partially treated with a fluorinated treating agent prior to or during step (i).

The composition as herein before described is free from fluorinated polydiorganosiloxane polymers containing silanol groups and having greater than (>) 20 repeating siloxane units.

For the sake of this application the term “free from” shall be understood to mean does not contain fluorinated polydiorganosiloxanes other than trace impurity amounts and residual unreacted filler treating agent.

Preferably the composition contains less than or equal to (≤) 0.1 wt. % of the composition of electrically conductive filler or electrically semi-conductive filler or a mixture thereof and in one embodiment the composition described above contains 0 (zero) wt. % of electrically conductive filler or electrically semi-conductive filler.

When (C), a hydrosilylation cure package, is present in the composition the non-fluorinated polydiorganosiloxane (A) must contain at least one, alternatively at least two unsaturated groups such as alkenyl or alkynyl groups per molecule. However, when component (D) is the only means of catalysis for the cure process the presence of at least one alkenyl or alkynyl group per molecule alternatively at least two alkenyl or alkynyl groups per molecule in component (A) is preferred but is not essential.

For the purpose of this application “Substituted” means one or more hydrogen atoms in a hydrocarbon group has been replaced with another substituent. Examples of such substituents include, but are not limited to, halogen atoms such as chlorine, bromine, and iodine; halogen atom containing groups (other than fluoro) such as chloromethyl; oxygen atoms; oxygen atom containing groups such as (meth)acrylic and carboxyl; nitrogen atoms; nitrogen atom containing groups such as amino-functional groups, amido-functional groups, and cyano-functional groups; sulphur atoms; and sulphur atom containing groups such as mercapto groups.

It has been found herein that silicone rubber compositions containing non-fluorinated silicone polymers and reinforcing silica fillers, where at least a part of the silica is treated with a fluorinated hydrophobing treating agent selected from

one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s) or a mixture thereof;
are showing greater effect in changing the electrical properties of silicone rubber into a conductive range matching the desired XLPE volume resistivity values. The modified silica treatment using said fluorinated treating agent acts in reducing the volume resistivity of silicone rubber to at most 60% of the volume resistivity for a comparable silicone rubber prepared without the modified silica treatment, which is the desired targeted range which equates to the typical volume resistivity of the XLPE material used as the cable insulation. It has surprisingly been identified that using silica at least partially treated with said fluorinated treating agent can potentially be used in combination with different silicone rubbers such as liquid silicone rubber (LSR) and high consistency rubber (HCR) to target the electrical properties of these materials to desired ranges by varying the content of silica treated with said fluorinated treating agent within the range of treated silica required in the composition.

Surprisingly it has been identified that no fluorinated polydiorganosiloxane polymers electrically conductive fillers or electrically semi-conductive fillers are necessary in the silicone rubber compositions herein to obtain silicone elastomers having a desired volume resistivity, if one varies the content of silica treated with said fluorinated treating agent within the amount of treated silica in the current compositions. It will also be shown that the silicone rubber formulations which can be utilised may include liquid silicone rubber compositions or high consistency silicone rubber-based materials utilising polydiorganosiloxane polymer gums. By using the silica treated with said fluorinated treating agent as the only fluorinated part of the composition it has been identified that we are able to efficiently access a wide range of volume resistivities whilst only changing the loading of the silica treated with said fluorinated treating agent as shown in the examples, which is then much more economic than previous solutions and has the advantage of avoiding the previously mentioned compatibility etc. type issues previously encountered with previous solutions to this problem.

Non-fluorinated polydiorganosiloxane polymer (A), has multiple units of the formula (I):

RₐSiO_{(4-a)/2} (I)

in which each R is independently selected from an aliphatic hydrocarbyl, aromatic hydrocarbyl, or organyl group (that is any organic substituent group, regardless of functional type, having one free valence at a carbon atom). Saturated aliphatic hydrocarbyls are exemplified by, but not limited to alkyl groups such as methyl, ethyl, propyl, pentyl, octyl, undecyl, and octadecyl and cycloalkyl groups such as cyclohexyl. Unsaturated aliphatic hydrocarbyls are exemplified by, but not limited to, alkenyl groups such as vinyl, allyl, butenyl, pentenyl, cyclohexenyl and hexenyl; and by alkynyl groups. Aromatic hydrocarbon groups are exemplified by, but not limited to, phenyl, tolyl, xylyl, benzyl, styryl, and 2-phenylethyl. Organyl groups are exemplified by, but not limited to, halogenated alkyl groups (excluding fluoro containing groups) such as chloromethyl and 3-chloropropyl; nitrogen containing groups such as amino groups, amido groups, imino groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. The subscript “a” is 0, 1, 2 or 3.

Siloxy units may be described by a shorthand (abbreviated) nomenclature, namely—“M,” “D,” “T,” and “Q”, when R is a methyl group (further teaching on silicone nomenclature may be found in Walter Noll, Chemistry and Technology of Silicones, dated 1962, Chapter I, pages 1-9). The M unit corresponds to a siloxy unit where a=3, that is R₃SiO_{1/2}; the D unit corresponds to a siloxy unit where a=2, namely R₂SiO_{2/2}; the T unit corresponds to a siloxy unit where a=1, namely R₁SiO_{3/2}; the Q unit corresponds to a siloxy unit where a=0, namely SiO_{4/2}.

Examples of typical groups on the non-fluorinated polydiorganosiloxane polymer (A) include mainly alkenyl, alkyl, and/or aryl groups. The groups may be in pendent position (on a D or T siloxy unit) or may be terminal (on an M siloxy unit). As previously indicated alkenyl and/or alkynyl groups are essential when component (C) is involved in the cure process but are optional if the sole catalyst for the cure process is component (D). Hence, when present, suitable alkenyl groups in component (A) typically contain from 2 to 10 carbon atoms, with preferred examples being vinyl, isopropenyl, allyl, and 5-hexenyl.

The silicon-bonded organic groups attached to component (A) other than alkenyl groups are typically selected from monovalent saturated hydrocarbon groups, which typically contain from 1 to 10 carbon atoms, and monovalent aromatic hydrocarbon groups, which typically contain from 6 to 12 carbon atoms, which are unsubstituted or substituted with the groups that do not interfere with curing of this inventive composition, such as halogen atoms. Preferred species of the silicon-bonded organic groups are, for example, alkyl groups such as methyl, ethyl, and propyl; and aryl groups such as phenyl.

The non-fluorinated polydiorganosiloxane polymer may be selected from polydimethylsiloxanes, alkylmethylpolysiloxanes, alkylarylpolysiloxanes or copolymers thereof (where reference to alkyl means an alkyl group having two or more carbons) containing e.g. alkenyl and/or alkynyl groups and may have any suitable terminal groups, for example, they may be trialkyl terminated, alkenyldialkyl terminated alkynyldialkyl terminated or may be terminated with any other suitable terminal group combination providing each polymer contains at least two unsaturated groups selected from alkenyl and alkynyl groups per molecule. Preferably, the terminal groups of such a polymer have less than (<) 10 wt. % of silanol terminal groups, alternatively no silanol terminal groups. Hence the non-fluorinated polydiorganosiloxane polymer may be, for the sake of example, dimethylvinyl terminated polydimethylsiloxane, dimethylvinylsiloxy-terminated dimethylmethylphenylsiloxane, trialkyl terminated dimethylmethylvinyl polysiloxane or dialkylvinyl terminated dimethylmethylvinyl polysiloxane copolymers.

The molecular structure of component (A) is typically linear, however, there can be some branching due to the presence of T units (as previously described) within the molecule. To achieve a useful level of physical properties in the elastomer prepared by curing the composition as hereinbefore described the molecular weight of component (A) should be sufficient so that it achieves a viscosity of at least 1000 mPa·s at 25° C. relying on the cup/spindle method of ASTM D 1084 Method B, using the most appropriate spindle from the Brookfield® RV or LV range for the viscosity range. The upper limit for the molecular weight of component (A) is not specifically restricted and is typically limited only by the processability of the LSR composition of the present.

However, (A) may be a gum. A polydiorganosiloxane gum typically has a viscosity of at least 1,000,000 mPa·s at 25° C. However, because of the difficulty in measuring viscosity above these values, gums tend to be described by way of their Williams plasticity values in accordance with ASTM D-926-08 as opposed to by viscosity. Hence, a polydiorganosiloxane gum (A) has a viscosity resulting in a Williams's plasticity of at least 30 mm/100 measured in accordance with ASTM D-926-08, alternatively at least 50 mm/100 measured in accordance with ASTM D-926-08, alternatively at least 100 mm/100 measured in accordance with ASTM D-926-08, alternatively from 100 mm/100 to 300 mm/100 in accordance with ASTM D-926-08.

Examples of component (A) are polydiorganosiloxanes containing alkenyl groups at the two terminals and are represented by the general formula (II):

R′R″R′″SiO—(R″R′″SiO)ₘ—SiOR′″R′″R′ (II)

In formula (II), each R′ is an alkenyl group, which typically contains from 2 to 10 carbon atoms, such as vinyl, allyl, and 5-hexenyl.

R″ does not contain ethylenic unsaturation, Each R″ may be the same or different and is individually selected from monovalent saturated hydrocarbon group, which typically contain from 1 to 10 carbon atoms, and monovalent aromatic hydrocarbon group, which typically contain from 6 to 12 carbon atoms. R″ may be unsubstituted or substituted with one or more groups that do not interfere with curing of this inventive composition, such as halogen (excluding fluorine) atoms. R′″ is R′ or R″. For the avoidance of doubt, no R′″, R′ or R″ groups in component (A) polymers may contain fluoro groups or any fluorine containing groups. As discussed above, when the polymer is designed to be used as part of an LSR composition, the letter m represents a degree of polymerization suitable for component (A) to have a viscosity of from 1,000 mPa·s to 100,000 mPa·s at 25° C. relying on the cup/spindle method of ASTM D 1084 Method B, using the most appropriate spindle from the Brookfield® RV or LV range for the viscosity range. However, if (A) is in the form of a gum the value of m will be significantly greater as the viscosity thereof is >1,000,000 mPa·s at 25° C., often significantly >1,000,000 mPa·s at 25° C. and the Williams plasticity measurement is determined rather than viscosity.

The alkenyl and alkynyl group of component (A) is determined using quantitative infra-red analysis in accordance with ASTM E168.

### (B) Reinforcing Silica Filler

Component B is reinforcing silica filler which is at least partially hydrophobically treated with said fluorinated treating agent to achieve high level of physical properties that characterize some types of cured silicone elastomer that can be prepared using the composition herein, a reinforcing silica filler (B), such as a finely divided silica filler, which is at least partially hydrophobically treated with said fluorinated treating agent is provided.

The finely divided forms of silica may be, for example, selected from fumed silica, precipitated silica and/or colloidal silica. They are particularly preferred because of their relatively high surface area, which is typically at least 50 m²/g. Fillers having surface areas of from 100 to 600 m²/g measured in accordance with the BET method, alternatively of from 100 to 500 m²/g (using the BET method in accordance with ISO 9277: 2010), alternatively of from 200 to 400 m²/g (using the BET method in accordance with ISO 9277: 2010), are typically used.

When component B the reinforcing silica filler(s) are naturally hydrophilic (e.g. untreated silica fillers) they are often surface treated with one or more known filler treating agents to prevent a phenomenon referred to as “creping” or “crepe hardening” during processing of the curable composition.

The reinforcing silica filler(s) may be treated prior to introduction in the composition or in situ (i.e. in the presence of at least a portion of the other components of the composition as hereinbefore described by blending these components together until the filler is completely surface treated and uniformly dispersed to form a homogeneous material). In one embodiment, untreated filler (B) is treated in situ with a treating agent in the presence of component (A).

In the present composition reinforcing silica filler (B) is at least partially surface treated using a fluorinated hydrophobing treating agent selected from one or more silanol terminated fluorinated siloxane oligomer(s) having from 2 to 20 siloxane units, and/or

one or more fluorinated silane diol(s), and/or
one or more fluorinated trialkoxy silane(s), and/or
one or more fluorinated silazane(s) or a mixture thereof.

The fluorinated treating agent may comprise a silanol terminated

fluorinated siloxane oligomer comprising from 2 to 20 siloxane units having the formula

(R²Z)_{d}(R³)ₑSiO_{(4-d-e)/2}

### Wherein

each R² may be the same or different and denotes a branched or linear fluoroalkyl group having from 1 to 8 carbon atoms;
each Z may be the same or different and denotes a divalent alkylene group containing at least two carbon atoms, a hydrocarbon ether or a hydrocarbon thioether; with each R² group being linked to a silicon atom via a Z group,
each R³ is the same or different and denotes an alkyl group having from 1 to 10 carbons,
d may be from 1 to 3 and e may be from 0 to 3 with (d+e) being from 1 to 3.

Examples of suitable saturated R³ groups include alkyl groups, such as methyl, ethyl, propyl, isopropyl, n-butyl, t-butyl, hexyl, 2-ethylhexyl, octyl, isooctyl and decyl, alternatively having from 1 to 6 carbons, alternatively methyl, ethyl, propyl, isopropyl, n-butyl, or t-butyl, alternatively methyl or ethyl, alternatively methyl;

Preferably R² denotes a fluoroalkyl group having at least one carbon atom, alternatively having from 1 to 8 carbon atoms, over the complete range of from 5 to 100 mol % fluorinated siloxane units. Each fluoroalkyl group present has at least one —C—F bond. The R² groups can be identical or different and can have a normal or a branched structure. Preferably at least some, most preferably greater than 50 mol % of the fluoroalkyl groups are perfluoroalkyl groups. Examples thereof include CF₃—, C₂F₅—, C₃F₇—, such as CF₃CF₂CF₂— or (CF₃)₂CF—, C₄F₉—, such as CF₃CF₂CF₂CF₂—, (CF₃)₂CFCF₂—, (CF₃)₃C— and CF₃CF₂(CF₃)CF—; C₅F₁₁ such as CF₃CF₂CF₂CF₂CF₂—, C₆F₁₃—, such as CF₃(CF₂)₄CF₂—; C₇F₁₄—, such as CF₃(CF₂CF₂)₃—; and C₈F₁₇.

Each perfluoroalkyl group is bonded to a silicon atom by way of Z, a divalent spacing group containing carbon, hydrogen and, optionally, oxygen and/or sulphur atoms which are present as ether and thioether linkages, respectively. The sulphur and oxygen atoms, if present, must be bonded to only carbon atoms.

Each Z radical can have any structure containing the elements listed but is preferably an alkylene radical (i.e. an acyclic, branched or unbranched, saturated divalent hydrocarbon group). Examples of suitable alkylene radicals include —CH₂CH₂—, —CH₂CH₂CH₂—, —CH(CH₃)CH₂—, —(CH₂CH₂)₂— and —CH(CH₃)CH₂CH₂—. In one embodiment each fluorinated radical, R²Z, preferably has the formula R²CH₂CH₂—, i.e. Z is an ethylene group.

As indicated above, d may be from 1 to 3 and e may be from 0 to 3 with (d+e) being from 1 to 3, alternatively (d+e) is 2 or 3, alternatively (d+e) is 2 with d=1 and e=1. Preferably, when e is >0 at least 90 percent, and more preferably all of the R³ groups are methyl groups.

The fluorinated siloxane oligomer may additionally comprise a proportion of up to about 90%, alternatively up to about 80% of the total number of units per molecule of non-fluorinated siloxane units having the formula

(R⁴)_{c}SiO_{(4-c)/2}

wherein R⁴ denotes an optionally substituted saturated or unsaturated silicon-bonded, monovalent hydrocarbon group, wherein c=0 to 3 but preferably the average value of c is about 2. Each R⁴ contains no fluorine (and therefore R⁴ cannot contain any of the fluoro containing substituents previously identified.

As previously indicated R⁴ denotes an optionally substituted saturated or unsaturated silicon-bonded, monovalent hydrocarbon group. Preferably each R⁴ may be the same or different and is selected from C₁ to C₁₀ alkyl groups; alkenyl groups such as vinyl or allyl groups; and/or aryl groups such as such as phenyl, tolyl, benzyl, beta-phenylethyl, and styryl. When present, each alkenyl group will have from 2 to 8 carbon atoms, alternatively each alkenyl group is a vinyl group.

The fluorinated siloxane oligomer having from 2 to 20 siloxane units maybe exemplified through the following formula

H—O—[(R²Z)_{d}(R³)ₑSi—O]_{f}—H

wherein R², Z, d, R³, and e are as defined above and f is from 2 to 20.

The fluorinated silane diol maybe exemplified by the formula

(HO)₂Si(R²Z)(R³)

wherein R², Z and R³ are each as defined above.

The fluorinated trialkoxy silane maybe exemplified by the formula

R²Z—Si(R^{g})₃

wherein R² is as defined above and each R^{g} may be the same or different and is an alkoxy group having from 1 to 6 carbons, alternatively and alkoxy group having from 1 to 4 carbons, alternatively is a t-butoxy, ethoxy or methoxy group.

The fluorinated silazane maybe exemplified by the formula

((R²Z)(R³)₂—Si)₂—NH

wherein R², Z and R³ are each as defined above. In one alternative each R³ has from 1 to 6 carbons, alternatively 1 to 3 carbons, alternatively is ethyl or methyl.

The fluorinated treating agents may for example be selected from the group of trifluoropropyltrialkoxysilanes, such as trifluoropropyltrimethoxysilane and trifluoropropyltriethoxysilane; silanol terminated trifluoropropylalkyl siloxanes having from 2 to 20 siloxane repeating units and wherein the alkyl groups have 1 to 6 carbons such as silanol terminated trifluoropropylmethyl siloxane having from 2 to 20 siloxane repeating units and silanol terminated trifluoropropylethyl siloxane having from 2 to 20 siloxane repeating units and bis(trifluoropropyldialkyl)silazanes where each alkyl group has 1 to 6 carbons, alternatively 1 to 3 carbons, alternatively is a methyl or ethyl group.

The treating agents are used primarily to render the filler(s) hydrophobic and therefore easier to handle and obtain a homogeneous mixture with the other components, although as previously discussed it has been determined here that by varying the amount of reinforcing filler treated with one or more of the fluorinated treating agents described above the volume resistivity of the resulting elastomeric material may be varied.

The remainder of reinforcing silica (B) (if any) is treated using a non-fluorinated hydrophobing treating agent such as, for the sake of example, organosilanes, polydiorganosiloxanes, or organosilazanes, hexaalkyl disilazane, short chain siloxane diols, a fatty acid or a fatty acid ester such as a stearate; all of which are non-fluorinated. Again, this is to render the residual reinforcing silica (B) fillers(s) hydrophobic and therefore easier to handle and obtain a homogeneous mixture with the other ingredients.

Specific examples include but are not limited to non-fluorinated liquid hydroxyl-terminated polydiorganosiloxane containing an average from 2 to 20 repeating units of diorganosiloxane, hexaorganodisiloxane, hexaorganodisilazane, and the like.

In either treatment case described above, a small amount of water or ammonium hydroxide may be added together with the silica treating agent(s) as processing aid. The surface treatment of the fillers makes them easily wetted by the polymers of component (A). These surface modified fillers do not clump and can be homogeneously incorporated into component (A) resulting in improved room temperature mechanical properties of the uncured compositions.

The amount of silica reinforcing filler used in the compositions described herein is typically from about 1 to 40 wt. % (weight %) of the composition, alternatively 5 to 35 wt. % of the composition, alternatively from 10 to 35 wt. % of the composition alternatively from 15 to 35 wt. % of the composition. The treating agent utilised is typically added in an amount of from 1 to 10 wt. % of the total composition (i.e. after mixing part A and part B when stored as a multipart composition, alternatively from 1 to 10 wt. % of the total composition.

In one embodiment, at least 20 wt. % of the total silica surface is treated using a fluorinated hydrophobing treating agent. This fluorinated hydrophobing treating agent may be uniformly distributed across all silica surface, when a mixture of said fluorinated treating agents and non-fluorinated treating agents are applied onto the silica simultaneously, or concentrated on certain portions of the silica surface where treated separately or sequentially, as desired using a suitable treating process or treating the silica in situ; alternatively, at least 30 wt. % of the total weight of reinforcing silica (B); alternatively, at least 40 wt. % of the total weight of reinforcing silica (B); alternatively, at least 50 wt. % of the total weight of reinforcing silica (B); alternatively, at least 60 wt. % of the total weight of reinforcing silica (B); alternatively, at least 80 wt. % of the total weight of reinforcing silica (B) or alternatively, 100 wt. % of the total weight of reinforcing silica (B). In the above the maximum in each instance is wt. % of the total weight of reinforcing silica (B).

The composition is cured using a curing package of at least one of components (C), (D) or a mixture of components (C) and (D) wherein
(C) is at least one organohydrogenpolysiloxane (C)(i), at least one hydrosilylation catalyst (C)(ii) and optionally at least one cure inhibitor (C)(iii); and
(D) is at least one peroxide catalyst.

### (C)(i) Organohydrogenpolysiloxane

When present, component (C)(i) is an organohydrogenpolysiloxane, which operates as a cross-linker for curing component (A), by the addition reaction of the silicon-bonded hydrogen atoms in component (C)(i) with the alkenyl groups in component (A) under the catalytic activity of component (C)(ii). Component (C)(i) normally contains 3 or more silicon-bonded hydrogen atoms so that the hydrogen atoms of this component can sufficiently react with the alkenyl groups of component (A) to form a network structure therewith and thereby cure the composition. Some or all of Component (C)(i) may alternatively have 2 silicon bonded hydrogen atoms per molecule when component (A) has >2 alkenyl or alkynyl, alternatively alkenyl groups per molecule.

The molecular configuration of component (C)(i) is not specifically restricted, and it can be straight chain, branch-containing straight chain, or cyclic. While the viscosity of this component is not specifically restricted, it may typically be from 0.001 to 50 Pa·s at 25° C. relying on the cup/spindle method of ASTM D 1084 Method B, using the most appropriate spindle from the Brookfield® RV or LV range for the viscosity range, in order to obtain a good miscibility with component (A).

Component (C)(i) is typically added in an amount such that the molar ratio of the total number of the silicon-bonded hydrogen atoms in component (C)(i) to the total number of all alkenyl and alkynyl groups, alternatively alkenyl groups in component (A) is from 0.5:1 to 20:1. When this ratio is less than 0.5:1, a well-cured composition will not be obtained. When the ratio exceeds 20:1, there is a tendency for the hardness of the cured composition to increase when heated. The silicon-bonded hydrogen (Si—H) content of organohydrogenpolysiloxane (C)(i) is determined using quantitative infra-red analysis in accordance with ASTM E168.

Examples of component (C)(i) include but are not limited to:

(i) trimethylsiloxy-terminated methylhydrogenpolysiloxane,
(ii) trimethylsiloxy-terminated polydimethylsiloxane-methylhydrogensiloxane,
(iii) dimethylhydrogensiloxy-terminated dimethylsiloxane-methylhydrogensiloxane copolymers,
(iv) dimethylsiloxane-methylhydrogensiloxane cyclic copolymers,
(v) copolymers composed of (CH₃)₂HSiO_{1/2} units and SiO_{4/2} units,
(vi) copolymers composed of (CH₃)₃SiO_{1/2} units, (CH₃)₂HSiO_{1/2} units, and SiO_{4/2} units; and
(vii) copolymers containing (CH₃)₂HSiO_{1/2} units and (R²Z)_{d}(R³)ₑ SiO_{(4-d-e)/2} as described above.

Typically component (C)(i) is present in the composition in an amount of from 0.5 to 10 wt. % of the total composition which amount is determined dependent on the required molar ratio of the total number of the silicon-bonded hydrogen atoms in component (C)(i) to the total number of all alkenyl and alkynyl groups as previously discussed.

### (C)(ii) Hydrosilylation Catalyst

When present, hydrosilylation catalyst (C)(ii) is one of the platinum metals (platinum, ruthenium, osmium, rhodium, iridium and palladium), or a compound of one or more of such metals. Platinum and platinum compounds are preferred due to the high activity level of these catalysts in hydrosilylation reactions.

Example of preferred hydrosilylation catalysts (C)(ii) include but are not limited to platinum black, platinum on various solid supports, chloroplatinic acids, alcohol solutions of chloroplatinic acid, and complexes of chloroplatinic acid with ethylenically unsaturated compounds such as olefins and organosiloxanes containing ethylenically unsaturated silicon-bonded hydrocarbon groups. The catalyst (C)(ii) can be platinum metal, platinum metal deposited on a carrier, such as silica gel or powdered charcoal, or a compound or complex of a platinum group metal.

Examples of suitable platinum-based catalysts include

(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum in a solvent, such as toluene may be used. These are described in U.S. Pat. Nos. 3,715,334 and 3,814,730.

The hydrosilylation catalyst (C)(ii) when present, is present in the total composition in a catalytic amount, i.e. an amount or quantity sufficient to promote a reaction or curing thereof at desired conditions. Varying levels of the hydrosilylation catalyst (C)(ii) can be used to tailor reaction rate and cure kinetics. The catalytic amount of the hydrosilylation catalyst (C)(ii) is generally between 0.01 ppm, and 10,000 parts by weight of platinum-group metal, per million parts (ppm), based on the combined weight of the composition components (a) and (b); alternatively between 0.01 and 5000 ppm; alternatively between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst package is provided the amount of catalyst present will be within the range of from 0.001 to 3.0 wt. % of the composition.

### Inhibitor (C)(iii)

Compositions of the aforementioned components (A), (C)(i), and (C)(ii) may begin to cure at ambient temperature. To obtain a longer working time or pot life of a hydrosilylation cured composition when (C)(i) and (C)(ii) are present a suitable hydrosilylation reaction inhibitor (C)(iii) may also be used in order to retard or suppress the activity of the catalyst. Hydrosilylation reaction inhibitors are well known in the art and include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines.

One class of known hydrosilylation reaction inhibitor includes the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargylalcohol, 1-phenyl-2-propyn-1-ol, 3,5-dimethyl-1-hexyn-3-ol, 1-ethynylcyclopentanol, 3-methyl-1-penten-4-yn-3-ol, and mixtures thereof. Derivatives of acetylenic alcohol may include those compounds having at least one silicon atom.

When present, inhibitor concentrations as low as 1 mole of inhibitor per mole of the metal of catalyst (C)(ii) will in some instances impart satisfactory storage stability and cure rate. In other instances, inhibitor concentrations of up to 500 moles of inhibitor per mole of the metal of catalyst (C)(ii) are required. The optimum concentration for a given inhibitor in a given composition is readily determined by routine experimentation. Dependent on the concentration and form in which the inhibitor selected is provided/available commercially, when present in the composition, the inhibitor is typically present in an amount of from 0.0125 to 10 wt. % of the composition.

When component C is relied upon to cure the composition, typically the composition will be stored in two parts, often referred to as Part A and Part B with a view to separating components (C)(i) and (C)(ii) prior to cure. Typically, when present, component (C)(iii) is present in the same part as the cross-linker (C)(i). Such 2-part compositions are designed to enable easy mixing immediately prior to use and are typically in a weight ratio of Part A:Part B of from 15:1 to 1:1.

### (D) Peroxide Catalyst

The composition as described herein may alternatively or additionally be cured with a peroxide catalyst (D) or mixtures of different types of peroxide catalysts.

The peroxide catalyst may be any of the well-known commercial peroxides used to cure fluorosilicone elastomer compositions. The amount of organic peroxide used is determined by the nature of the curing process, the organic peroxide used, and the composition used. Typically, the amount of peroxide catalyst utilised in a composition as described herein is from 0.2 to 3 wt. %, alternatively 0.2 to 2 wt. % in each case based on the weight of the composition.

Suitable organic peroxides are substituted or unsubstituted dialkyl-, alkylaroyl-, diaroyl-peroxides, e.g. benzoyl peroxide and 2,4-dichlorobenzoyl peroxide, ditertiarybutyl peroxide, dicumyl peroxide, t-butyl cumyl peroxide, bis(t-butylperoxyisopropyl) benzene bis(t-butylperoxy)-2,5-dimethyl hexyne 2,4-dimethyl-2,5-di(t-butylperoxy) hexane, di-t-butyl peroxide and 2,5-bis(tert-butyl peroxy)-2,5-dimethylhexane. Mixtures of the above may also be used.

### Optional Additional Ingredients

Additional optional ingredients may be present in the silicone rubber composition depending on the intended use thereof. Examples of such optional ingredients include thermally conductive fillers, non-conductive fillers, pot life extenders, flame retardants, lubricants, non-reinforcing fillers, compression set additives, pigments, coloring agents, adhesion promoters, chain extenders, silicone polyethers, mold release agents, diluents, solvents, UV light stabilizers, bactericides, wetting agents, heat stabilizers, compression set additives, plasticizers, and mixtures thereof.

Pot life extenders, such as triazole, may be used, but are not considered necessary in the scope of the present invention. The liquid curable silicone rubber composition may thus be free of pot life extender.

Examples of flame retardants include aluminium trihydrate, magnesium hydroxide, chlorinated paraffins, hexabromocyclododecane, triphenyl phosphate, dimethyl methylphosphonate, tris(2,3-dibromopropyl) phosphate (brominated tris), and mixtures or derivatives thereof.

Examples of lubricants include graphite, talc, boron nitride, molybdenum disulfide, and mixtures or derivatives thereof.

Further additives include silicone fluids, such as trimethyl terminated or dimethylhydroxy terminated siloxanes. typically have a viscosity <150 mPa·s at 25° C. relying on the cup/spindle method of ASTM D 1084 Method B, using the most appropriate spindle from the Brookfield® RV or LV range for the viscosity range. When present such silicone fluid may be present in the liquid curable silicone rubber composition in an amount ranging of from 0.1 to 5% by weight (% wt.), based on the total weight of the composition.

Examples of pigments include titanium dioxide, chromium oxide, bismuth vanadium oxide, iron oxides and mixtures thereof.

Examples of adhesion promoters include alkoxysilane containing methacrylic groups or acrylic groups such as methacryloxymethyl-trimethoxysilane, 3-methacryloxypropyl-tirmethoxysilane, 3-methacryloxypropyl-methyldimethoxysilane, 3-methacryloxypropyl-dimethylmethoxysilane, 3-methacryloxypropyl-triethoxysilane, 3-methacryloxypropyl-methyldiethoxysilane, 3-methacryloxyisobutyl-trimethoxysilane, or a similar methacryloxy-substituted alkoxysilane; 3-acryloxypropyl-trimethoxysilane, 3-acryloxypropyl-methyldimethoxysilane, 3-acryloxypropyl-dimethyl-methoxysilane, 3-acryloxypropyl-triethoxysilane, or a similar acryloxy-substituted alkyl-containing alkoxysilane; zirconium chelate compound such as zirconium (IV) tetraacetyl acetonate, zirconium (IV) hexafluoracetyl acetonate, zirconium (IV) trifluoroacetyl acetonate, tetrakis (ethyltrifluoroacetyl acetonate) zirconium, tetrakis (2,2,6,6-tetramethyl-heptanethionate) zirconium, zirconium (IV) dibutoxy bis(ethylacetonate), diisopropoxy bis (2,2,6,6-tetramethyl-heptanethionate) zirconium, or similar zirconium complexes having β-diketones (including alkyl-substituted and fluoro-substituted forms thereof) and epoxy-containing alkoxysilanes such as 3-glycidoxypropyl trimethoxysilane, 3-glycidoxypropyl triethoxysilane, 3-glycidoxypropyl methyldimethoxysilane, 4-glycidoxybutyl trimethoxysilane, 5,6-epoxyhexyl triethoxysilane, 2-(3,4-epoxycyclohexyl) ethyltrimethoxysilane, or 2-(3,4-epoxycyclohexyl) ethyltriethoxysilane.

Examples of chain extenders include disiloxane or a low molecular weight polyorganosiloxane containing two silicon-bonded hydrogen atoms in terminal positions. The chain extender typically reacts with alkenyl groups of component (A), thereby linking two or more molecules of component (A) together and increasing its effective molecular weight and the distance between potential cross-linking sites.

A disiloxane is typically represented by the general formula (HR^{a}₂Si)₂O. When the chain extender is a polyorganosiloxane, it has terminal units of the general formula HR^{a}₂SiO_{1/2} and non-terminal units of the formula R^{b}₂SiO. In these formulae, R^{a} and R^{b} individually represent unsubstituted or substituted monovalent hydrocarbon groups that are free of ethylenic unsaturation and fluoro content, which include, but are not limited to alkyl groups containing from 1 to 10 carbon atoms, substituted alkyl groups containing from 1 to 10 carbon atoms such as chloromethyl, cycloalkyl groups containing from 3 to 10 carbon atoms, aryl containing 6 to 10 carbon atoms, alkaryl groups containing 7 to 10 carbon atoms, such as tolyl and xylyl, and aralkyl groups containing 7 to 10 carbon atoms, such as benzyl.

Further examples of chain extenders include tetramethyldihydrogendisiloxane or dimethylhydrogen-terminated polydimethylsiloxane.

A chain extender may be added in an amount from 1 to 10 parts by weight, based on the weight of component (A), typically 1 to 10 parts per 100 parts of component (A).

Examples of heat stabilizers include metal compounds such as red iron oxide, yellow iron oxide, ferric hydroxide, cerium oxide, cerium hydroxide, lanthanum oxide, copper phthalocyanine, aluminum hydroxide, fumed titanium dioxide, iron naphthenate, cerium naphthenate, cerium dimethylpolysilanolate and acetylacetone salts of a metal chosen from copper, zinc, aluminum, iron, cerium, zirconium, titanium and the like. The amount of heat stabilizer present in a composition may range from 0.01 to 1.0 wt. % of the total composition.

The present invention thus provides a silicone rubber composition, which comprises:

Component (A) in an amount of from 40 to 95 wt. % of the composition.
Component (B) in an amount of from 5 to 60 wt. % of the composition. The total weight % of the composition being 100 wt. % for any composition.

When the composition is cured via hydrosilylation the composition may comprise 0.5 to 10 wt. % of component (C)(i), 0.01 to 1 wt. % component (C)(ii) and from 0 to 1 weight % of component (C)(iii). The total weight % of the composition being 100 wt. % for any composition. In such cases the composition will be stored prior to use in two parts Part A and Part B. Typically, Part A will contain some of Component (A), some of Component (B) and Component (C)(ii) and part B will contain the remainder of components (A) and (B) together with components (C)(i). Optional inhibitor (C)(iii) when present may be present in either or both of the part (A) or part (B) compositions. The optional ingredients present in the composition may introduced either or both the part A composition or the part B composition as desired providing they do not cause any negative effect to the respective part. The two-part composition may be designed to be mixed together in any suitable ratio e.g. from 15:1 to 1:1. In cases where the ratio is 15:1 or greater part B may comprise only cross-linker (C)(i) and optionally inhibitor (C)(iii).

The curable silicone elastomer composition described above may be prepared by
(i) making a silicone base composition by mixing non-fluorinated polydiorganosiloxane (A) with at least one reinforcing silica filler and
(ii) introducing components (C), component (D) or a mixture of component (C) and component (D) and storing the resulting composition; wherein when the composition contains hydrosilylation cure package (C) the composition is stored in two or more parts with components (C)(i) and (C) (ii) being kept in separate parts;
   characterised in that the at least one reinforcing silica filler is at least partially treated with a fluorinated treating agent, as hereinbefore described, either prior to or during step (i).

In one embodiment the reinforcing silica filler treated with treating agent prior to step (i) of the process. In this embodiment all the reinforcing silica filler is treated with a fluorinated treating agent prior to step (i) or alternatively the reinforcing silica filler is partially treated with a fluorinated treating agent prior to step (i) and the remainder is treated with a non-fluorinated treating agent prior to step (i). In this embodiment once the reinforcing silica filler has been treated prior to step (i) the treated reinforcing silica filler is mixed with non-fluorinated polydiorganosiloxane (A) to form the base resulting from step (i) of the process. In a further alternative the silica may be treated by a mixture of fluorinated treating agent(s) and non-fluorinated treating agents simultaneously or sequentially.

In an alternative embodiment non-fluorinated polydiorganosiloxane (A) may be divided into multiple predetermined aliquots with each aliquot being mixed with a predetermined amount of reinforcing silica filler and a fluorinated treating agent or non-fluorinated treating agent in situ such that multiple partial bases are prepared with the reinforcing silica filler being treated in situ and then subsequently the multiple partial bases are mixed together to obtain the final product of step (i). In this embodiment at least one aliquot of non-fluorinated polydiorganosiloxane (A) is mixed with a fluorinated treating agent.

In an alternative embodiment the non-fluorinated polydiorganosiloxane (A) is mixed with one or multiple aliquots of the reinforcing silica filler and one or multiple aliquots of the fluorinated treating agent in situ such that the reinforcing silica filler is treated in situ to obtain the final product of step (i).

In an alternative embodiment the non-fluorinated polydiorganosiloxane (A) is mixed with one or multiple aliquots of the reinforcing silica filler and one or multiple aliquots of a mixture of, from 0 to 100 wt. % fluorinated treating agent and from 0 to 100 wt. % non-fluorinated treating agent in situ such that the reinforcing silica filler is treated in situ to obtain the final product of step (i), with the proviso that, on average, at least 20 wt. % of the silica is treated with the fluorinated treating agent.

The resulting product of step (i) may be divided for use as a base for part A and as a base for part B. Alternatively, when the composition is being hydrosilylation cured two separate bases may be prepared at the end of step (i). These may have the same or a different composition. For example, the base for part A composition may have utilised the fluorinated treating agent, a non-fluorinated treating agent or a mixture of said fluorinated treating agent and non-fluorinated treating agents. Likewise, the base for part B composition may have utilised a fluorinated treating agent, a non-fluorinated treating agent or a mixture of fluorinated treating agent and non-fluorinated treating agents. In each instance, at least the base for part A composition or the base for part B composition must comprise reinforcing silica filler at least partially treated with fluorinated treating agent.

Irrespective of the method for achieving the above the amount of amount of reinforcing silica filler treated with a fluorinated treating agent present in the composition is designed to provide an elastomeric product upon cure with a volume resistivity within a predefined range so as to be compatible with the volume resistivity of neighbouring cable insulation or the like, for example cross-linked polyethylene.

Any mixing techniques and devices described in the prior art can be used for this purpose. The particular device to be used will be determined by the viscosities of individual components and the final curable coating composition. Suitable mixers include but are not limited to paddle type mixers and kneader type mixers. Cooling of components during mixing may be desirable to avoid premature curing of the composition.

When the composition herein is designed to be an LSR composition, the viscosity of the composition ranges of from 10 to 1,000 Pa·s, alternatively of from 10 to 500 Pa·s, alternatively of from 100 to 500 Pa·s in each case at 25° C. measured using a cone and plate rheometer at 10's or relying on Williams plasticity measurements for the most viscous materials where (A) comprises at least one gum.

The present silicone rubber composition may alternatively be further processed by injection moulding, encapsulation moulding, press moulding, dispenser moulding, extrusion moulding, transfer moulding, press vulcanization, centrifugal casting, calendering, bead application or blow moulding.

Curing of the curable silicone rubber composition may be carried out as required by the type of silicone rubber utilized. Typical curing temperatures may range of from 80 to 200° C., alternatively of from 100 to 170° C. The time for the cure will depend on the cure temperature and method chosen but will typically be approximately from 5 minutes to 1 hour. Furthermore, if required the resulting cured elastomers may be post cured. Any suitable post cure may be undertaken if desired. For example, the cured elastomer may be post cured in an oven at a temperature of from 150 to 250° C., alternatively of from 170° C. to 230° C. for a pre-determined period of time e.g. 2 to 10 hours as required.

Curing can for example take place in a mold to form a moulded silicone article. The composition may for example be injection moulded to form an article, or the composition can be overmolded by injection moulding around an article or over a substrate.

There is also provided herein a high voltage insulator, alternatively a high voltage direct current insulator comprising an elastomeric product of a curable silicone elastomer composition described herein and/or a high voltage insulator, alternatively a high voltage direct current insulator comprising an elastomeric product obtained by curing a silicone elastomer composition as described herein. Typically, the composition contains less than or equal to (≤) 0.1 wt. % of the composition of electrically conductive filler or electrically semi-conductive filler or a mixture thereof and in one embodiment the composition described above contains 0 (zero) % by weight of electrically conductive filler.

The cured product of the above described composition may be used as a high voltage insulator adapted to reduce electrical stress in e.g. high voltage direct current (HVDC) applications, i.e. power cable systems or the like. As previously indicated, there is provided a high voltage insulator, alternatively a high voltage direct current insulator comprising an elastomeric product of a silicone elastomer composition described herein. A high voltage insulator, alternatively a high voltage direct current insulator may be used alone or may form part of an article or assembly e.g. a composite part of an assembly such as in cable accessories, as cable joint or cable termination materials, boots, sleeves and or other fittings in high voltage direct current applications, in field grading assemblies as a suitable insulating layer and in other suited cable accessories and connectors.

In a further embodiment there is provided a method for the manufacture of an insulator or a field grading assembly, comprising said insulator, for a high voltage insulator applications, alternatively high voltage direct current insulator (HVDC) applications, comprising the steps of: i) shaping a suitable amount of the silicone composition as hereinbefore described by an appropriate means e.g. for the sake of example by way of extrusion or using a mold and ii) curing the shaped composition to form a shaped insulator or a field grading assembly, comprising said insulator.

The high voltage insulator, alternatively a high voltage direct current insulator described above may be a part of a cable accessory for high voltage direct current applications such as a cable joint, cable termination or cable connector which can e.g. seals the ends of cables having a thermoplastic or rubber cable insulation.

The present invention further provides a method for sealing and/or insulating connected cables or closing cable ends by the use of the cable joint as described before, comprising the steps of (i) providing an insulated wire having a thermoplastic or elastomer multi-layered sheath appropriate for direct current insulation and naked wire or connectors, and (ii) encapsulating naked wire or connectors by putting over onto the surface of the insulating sheath of (i) the holes of a tube-like previously molded and cured cable joint as described before under mechanical extension of the joint in such a way that an overlap between the shaped silicone cable joint and the sheath onto the wire insulation of about more than 0.5 cm is achieved whereby the silicone cable joint seals the sheathed insulation of the insulated wire by mechanical pressure of the relaxed joint forming an encapsulating insulation also for the naked wire and connectors.

The composition as described herein may be used for the manufacture of a cable joint intended for sealing cable ends of one or more cables having a thermoplastic polyolefin or rubber cable insulation, wherein the cable joint seals cable ends of one or more cables having a thermoplastic polyolefin or rubber cable insulation.

The composition as hereinbefore described may be used in the manufacture of cable accessories, as cable joint or cable termination material in high voltage direct current applications, like for high-voltage direct current power cable applications. The cured silicone composition in accordance with the present invention can be used in the construction of all kinds of field grading assemblies, like geometric, capacitive, refractive, resistive or non-linear field grading assemblies for high voltage direct current (HVDC) applications. The cured silicone composition can be also used in field grading assemblies for high voltage direct current (HVDC) applications, where it essentially or exclusively acts in insulating layers as insulator which further contribute to electrical stress reduction in addition to the field grading materials. In certain cases, it may act also as field grading material, in particular, in resistive field grading assemblies. cable joints, cable terminal applications, cable accessories and connectors.

For example in the case of a high voltage direct current cable joint there may be provided a cable joint for connecting a pair of high voltage direct current power cables comprising a means for receiving and connecting a pair of high voltage direct current cables, layer of cable insulation adapted to surround the high voltage direct current cables when in said cable joint and a layer of silicone rubber joint insulation surrounding the cable insulation in said cable joint which silicone rubber joint insulation is as hereinbefore described and which is adapted to have a volume resistivity within a predefined range of the volume resistivity of the cable insulation. Preferably the cable insulation is made from cross-linked polyethylene. During assembly of the cable joint the volume resistivity of the cable insulation is determined e.g. in accordance with ASTM D257-14, a standard test method for DC Resistance or Conductance of Insulating Materials and then a suitable silicone rubber joint insulation material is prepared as described herein designed to have a similar volume resistivity in accordance with ASTM D257-14.

### EXAMPLES

In the following examples and compositions, all viscosities are given at 25° C. and were determined relying on the cup/spindle method of ASTM D 1084 Method B, using the most appropriate spindle from the Brookfield® RV or LV range for the viscosity range unless otherwise indicated. Williams plasticity values are provided in accordance with ASTM D-926-08. Vinyl content and Si—H content of polymers was determined by quantitative IR in accordance with ASTM E168.

### Example 1

Liquid Silicone Rubber compositions using non-fluorinated polydiorganosiloxane polymer were prepared as LSR Base 1 and LSR Base 2 as shown in Table 1a below. The fumed silica was treated in situ during preparation of the respective LSR Base.

TABLE 1a
Composition of LSR Base 1 and LSR Base 2 (wt. %)

| | LSR Base 1 | LSR Base 2 |
|---|---|---|
| Dimethylvinyl-terminated dimethyl siloxane | 73.9% | 71.0% |
| viscosity approximately 55 Pa · s | | |
| Trimethyl silyl treated fumed silica having | 26.1% | |
| surface area ~300 m²/g (BET) | | |
| Trifluoropropylmethylsiloxy treated fumed | | 29.0% |
| silica having surface area ~300 m²/g (BET) | | |

LSR Base 1 and LSR Base 2 were mixed together in the ratios as shown for examples 1.1 to 1.8 in Table 1.b

TABLE 1b
amounts of LSR Base 2 and LSR Base 1 in compositions

Proportion of each LSR base present (wt. %)

| Example | LSR Base 2 | LSR base 1 |
|---|---|---|
| 1.1 Comparative | 0 | 100 |
| 1.2 | 12.5 | 87.5 |
| 1.3 | 25 | 75 |
| 1.4 | 50 | 50 |
| 1.5 | 62.5 | 37.5 |
| 1.6 | 75 | 25 |
| 1.7 | 87.5 | 12.5 |
| 1.8 | 100 | 0 |

This mixture of the two bases as depicted in Table 1b was then mixed with the other ingredients to give a series of curable compositions which incorporate varying amount of fluorinated filler treated silica.as shown in table 1c.

TABLE 1c
Curable Formulations

| | Curable |
|---|---|
| | Formulation |
| | (wt. %) |
| Mix of LSR Base 1 and LSR Base 2 | 96.74 |
| Dimethylvinyl-terminated dimethyl methylvinyl | 2.311 |
| siloxane -viscosity 370 mPa · s, 1.16% vinyl | |
| 1-Ethynylcyclohexanol | 0.039 |
| Karstedt's catalyst (Platinum, 1,3-diethenyl- | 0.155 |
| 1,1,3,3-tetramethyldisiloxane complexes) diluted | |
| in dimethyl vinyl terminated siloxanes to give | |
| approximately 0.54 wt. % of Pt | |
| Dimethyl, methylhydrogen siloxane having 0.69 | 0.755 |
| wt. % H as SiH and a viscosity of 43 mPa · s | |

Given the samples were tested immediately a two-part composition was not required and the ingredients typically in the part B composition of a two-part composition as discussed above were mixed into each alternative mixture of LSR Base 1 and LSR Base 2 direct in accordance with Table 1c above.

The different samples produced were prepared as curable sheets were press cured for 10 mins @ 120° C. to form 0.5 mm thick cured sheets. Volume Resistivity was measured at room temperature with a polarization voltage of 1000 V and a polarization time of 60 s. It will be noted that 1.1 is deemed a comparative example as it is the only example in Table 1b which did not contain silica treated with the fluorinated treating agent.

Once cured Volume resistivity was measured in accordance with ASTM D257-14 Standard Test Methods for DC Resistance or Conductance of Insulating Materials on cured sheets ranging in thickness from 0.5 to 2 mm using a Keithley® 8009 test cell coupled with a Keithley® 5½-digit Model 6517B Electrometer/High Resistance Meter, controlled with Model 6524 High Resistance Measurement Software: D257.

Within the Model 6524 High Resistance Measurement Software an alternating polarity test was implemented as an “Hi-R” test to minimise the effects of background currents. This is described in detail in Keithley White Paper “Improving the Repeatability of Ultra-High Resistance and Resistivity Measurements” by Adam Daire.

The Hi-R alternating polarity test was used to minimise effects of background current. This method is designed to improve high resistance/resistivity measurements which are prone to large errors due to background currents.

An Alternating Polarity stimulus voltage was used with a view to isolating stimulated currents from background currents. When the Alternating Polarity method is used, the Voltage Source output of the electrometer alternates between two voltages: Offset Voltage+Alternating V, and Offset Voltage−Alternating V, at timed intervals (the Measure Time).

A current measurement (Imeas) is performed at the end of each alternation. After four Imeas values are collected, a current reading is calculated (Icalc). Icalc is the binomially weighted average of the last four current measurements (Imeas1 through Imeas4):

Icalc=(1*Imeas1−3*Imeas2+3*Imeas3−1*Imeas4)/8

The signs used for the four terms are the polarities of the alternating portion of the voltages generating the respective currents. This calculation of the stimulated current is unaffected by background current level, slope, or curvature, effectively isolating the stimulated current from the background current. The result is a repeatable value for the stimulated current and resistance or resistivity that are calculated from it. The time dependence of the stimulated current is a material property. That is, different results will be obtained when using different Measure Times, due to material characteristics.

A Measure Time of 60 seconds was used with 3 voltage cycles typically of +1000V then −1000V. From the 6 resulting measured currents the software obtains 3 Icalc values, the 1^{st} of these are rejected and then the subsequent 2 values used to calculate volume resistivity (VR) from

Volume Resistivity=(Vₘₐₓ−Vₘᵢₙ)×area/(2×Icalc×Sample Thickness)

The two resulting volume resistivity values were averaged to give a final value. The results for each combination are depicted in Table id below.

TABLE 1d
Volume Resistivity Results

| | Volume Resistivity (ohm-cm) |
|---|---|
| Example | 1000 V, 60 s, Room Temperature (RT) |
| 1.1 Comparative | 7.57 × 10¹⁴ |
| 1.2 | 3.27 × 10¹⁴ |
| 1.3 | 2.35 × 10¹⁴ |
| 1.4 | 1.89 × 10¹⁴ |
| 1.5 | 1.19 × 10¹⁴ |
| 1.6 | 4.92 × 10¹³ |
| 1.7 | 1.92 × 10¹³ |
| 1.8 | 4.93 × 10¹² |

Here examples 1.2 to 1.8 with different levels silica filler treated with the fluorinated treating agent show lower volume resistivity than 1.1 comparative which has no silica filler treated with the fluorinated treating agent.

Further samples of 1.2, 1.3, 1.4, 1.6 and 1.8 were prepared and in this instance they were post cured, for 4 hours (4 h) @ 200° C., and further volume resistivity testing was carried out at higher polarization voltages, longer polarization times and higher temperatures and these results are provided in Table 1e below.

TABLE 1e
Volume Resistivity Results at higher electrical
fields and longer polarization times.

| | | Volume Resistivity (ohm-cm) | | |
|---|---|---|---|---|
| | Temper- | Polarization Voltage, Polarization Time | | |
| Example | ature | 4,000 V, 2 h | 6,000 V 4 h | 8,000 V 12 h |
| 1.1 Comparative | 90° C. | 6.94 × 10¹⁵ | 1.30 × 10¹⁶ | 1.75 × 10¹⁶ |
| 1.3 | 90° C. | 1.00 × 10¹⁵ | 1.06 × 10¹⁵ | 1.15 × 10¹⁵ |
| 1.4 | 90° C. | 1.79 × 10¹⁴ | 2.03 × 10¹⁴ | 2.37 × 10¹⁴ |
| 1.6 | 90° C. | 2.27 × 10¹³ | 3.09 × 10¹³ | 5.81 × 10¹³ |
| 1.6 | 70° C. | 3.45 × 10¹³ | 4.47 × 10¹³ | 8.55 × 10¹³ |
| 1.6 | 40° C. | 6.49 × 10¹³ | 7.69 × 10¹³ | 1.08 × 10¹⁴ |
| 1.8 | 90° C. | 9.97 × 10¹² | 2.68 × 10¹³ | 5.01 × 10¹³ |

Here examples 1.4, 1.6 and 1.8 continue to show lower volume resistivity than 1.1 comparative under a range of polarization voltages, polarization times and temperatures.

### Example 2 High Consistency Rubber Examples

High consistency rubber bases were prepared. Blends of HCR 1 and HCR 2 with the compositions shown in Table 2a were prepared at various ratios as shown in Table 2b to provide examples 2.1 to 2.8. The base compositions utilised are described in Table 2a below.

TABLE 2a
Composition of HCR 1, HCR 2 and HCR 3

| | HCR 1 | HCR 2 | HCR 3 |
|---|---|---|---|
| | (wt. %) | (wt. %) | (wt. %) |
| Dimethylvinyl-terminated dimethyl | 45.47 | 44.35 | 48.1 |
| Siloxane gum having Williams plasticity | | | |
| of about 154 mm/100 having a vinyl | | | |
| content of 0.014 wt. % | | | |
| Dimethylvinyl-terminated dimethyl | 16.53 | 16.15 | 17.5 |
| methylvinyl Siloxane gum having Williams | | | |
| plasticity of about 155 mm/100 having a | | | |
| vinyl content of 0.067 wt. % | | | |
| Trimethyl silyl treated fumed silica with | 31.37 | | 16.8 |
| surface area ~300 m²/g (BET) - vinyl | | | |
| functionalization of about 0.051 mmol/g | | | |
| Trifluoropropylmethylsiloxy treated fumed | | 32.87 | 17.6 |
| silica with surface area ~300 m²/g | | | |
| (BET) - vinyl functionalization of about | | | |
| 0.051 mmol/g | | | |
| XIAMETER ™ RBM-9202 Catalyst | 0.47 | 0.47 | |
| XIAMETER ™ RBM-9200 Inhibitor | 1.49 | 1.49 | |
| XIAMETER ™ RBM-9201 Crosslinker | 4.67 | 4.67 | |

In HCR 1 and HCR 2 rather than the standard peroxide curing agent a commercially available hydrosilylation cure catalyst package (XIAMETER™ Addition Cure package from Dow Silicones Corporation of Midland Mich. USA) was used it comprises a platinum catalyst, an Si—H containing cross-linker and a cure inhibitor. These ingredients may be added in any suitable order for example, XIAMETER™ RBM-9200 Inhibitor, may be first added, followed by XIAMETER™ RBM-9202 Catalyst and lastly XIAMETER™ RBM-9201 Crosslinker. These are added in sequence with the inhibitor added first (when present). This should be well dispersed before Catalyst is added. The cross-linker was added last.

In the case of HCR 3 which was cured using a peroxide catalyst 100 parts by weight of the composition indicated in Table 2a above was mixed with 1 part by weight of which was a 45% paste of 2,5-Dimethyl-2,5-di(tert-butylperoxy)hexane in silicone. This is available commercially under a range of trade names such as DHBP-45-PSI (United Initiators). The volume resistivity results for HCR 3 were measured in the same manner as described above and were found to be 8.12×10¹³ ohm-cm.

### Cured Sheets

Cured sheets were prepared at 0.5 mm thickness using compression molds, a hydraulic press set at 300 psi (2.17 MPa) and a temperature of 120° C. for 10 minutes, cured sheets were suspended in vented ovens and post cured for up to 4 hours at 200° C. The volume resistivity results of the HCR1 and HCR 2 sheets were determined as described previously and are tabulated in Table 2b below.

TABLE 2b
Volume Resistivity Results

| | | | Average Volume |
|---|---|---|---|
| Example | % HCR 1 | % HCR 2 | Resistivity (ohm-cm) |
| 2.1 Comparative | 100.00 | 0.00 | 1.03 × 10¹⁵ |
| 2.2 Comparative | 100.00 | 0.00 | 1.06 × 10¹⁵ |
| 2.3 | 75.00 | 25.00 | 5.09 × 10¹⁴ |
| 2.4 | 50.01 | 49.99 | 2.36 × 10¹⁴ |
| 2.5 | 50.00 | 50.00 | 2.18 × 10¹⁴ |
| 2.6 | 24.98 | 75.02 | 4.71 × 10¹³ |
| 2.7 | 0.00 | 100.00 | 2.26 × 10¹² |
| 2.8 | 0.00 | 100.00 | 1.90 × 10¹² |

Here examples 2.3 to 2.8 with variable levels of silica filler treated with the fluorinated treating agent show lower volume resistivity than 2.1 or 2.2 comparatives which have no fluorinated siloxane treated silica.

Further samples of 2.1, 2.6 and 2.7 were prepared and in this instance they were post cured for up to 4 h @200° C., and further volume resistivity testing was carried out at higher polarization voltages, longer polarization times and higher temperatures and these results are provided in Table 2c below.

TABLE 2c
Volume Resistivity Results at higher electrical
fields and longer polarization times.

| | | Volume Resistivity (ohm-cm) | | |
|---|---|---|---|---|
| | Temper- | Polarization Voltage, Polarization Time | | |
| Example | ature | 4,000 V, 2 h | 6,000 V 1 h | 8,000 V 1 h |
| 2.1 Comparative | 90° C. | 3.28 × 10¹⁵ | 3.92 × 10¹⁵ | 4.43 × 10¹⁵ |
| 2.6 | 90° C. | 6.08 × 10¹² | 6.85 × 10¹² | 5.68 × 10¹² |
| 2.7 | 90° C. | 2.75 × 10¹² | 3.97 × 10¹² | 5.36 × 10¹² |

Examples 2.6 and 2.7 continue to show lower volume resistivity than 2.1 comparative under a range of polarization voltages and polarization times.

### Example 3

Liquid silicone rubber compositions using non-fluorinated polydiorganosiloxane polymer were prepared as LSR Base 3 and LSR Base 4 as shown in Table 3a below. The fumed silica was treated in situ during preparation of the LSR Base or HCR.

TABLE 3a
Composition of LSR Base 3 and LSR Base 4

| | LSR Base 3 | LSR Base 4 |
|---|---|---|
| Dimethylvinyl-terminated dimethyl siloxane | 72.4% | 75.3% |
| viscosity approximately 55 Pa · s | | |
| 50 mol % Trimethylsilyl and 50 mol % | 27.6% | |
| Trifluoropropylmethylsiloxy treated fumed | | |
| silica having surface area ~300 m²/g (BET) | | |
| 50 mol % Trimethylsilyl and 50 mol % | | 24.7% |
| Trifluoropropyldimethylsilyl treated fumed | | |
| silica having surface area ~300 m²/g (BET) | | |

Materials were cured using the same formulation as shown in table 1b except that the mix of LSR Base 1 and LSR Base 2 was replaced with either LSR base 3 or LSR base 4. Sheets of 0.5 mm thickness were cured for 10 mins @ 120° C. and were then measured for volume resistivity in the manner described above and the results are depicted in Table 3c below.

TABLE 3c
Volume Resistivity Results

| | | Average Volume |
|---|---|---|
| Example | LSR Base | Resistivity (ohm-cm) |
| 1.1 Comparative | 100% LSR Base 1 | 7.57 × 10¹⁴ |
| 1.4 | 50% LSR Base 1, | 1.89 × 10¹⁴ |
| | 50% LSR Base 2 | |
| 2.3 | LSR base 3 | 9.24 × 10¹³ |
| 2.4 | LSR Base 4 | 1.87 × 10¹² |

Thus, for these examples where the fumed silica is treated with a mixture of fluorinated and non-fluorinated treating agents show a lower volume resistivity than obtained for Example 1.4 where the LSR Base 1 and 2 are blended after silica treatment. All examples show reduced volume resistivity compared to comparative 1.1 regardless of method for preparing the mixture of fluorinated and non-fluorinated treating agents.

1. A curable silicone elastomer composition comprising:
(A) at least one non-fluorinated polydiorganosiloxane;
(B) at least one reinforcing silica filler which is at least partially hydrophobically treated with a fluorinated hydrophobing treating agent selected from;
one or more silanol terminated fluorinated siloxane oligomer(s) having from 2 to 20 siloxane units, and/or
one or more fluorinated silane diol(s), and/or
one or more fluorinated trialkoxy silane(s), and/or
one or more fluorinated silazane(s), or
a mixture thereof;
and at least one of component (C) or component (D):
(C) at least one organohydrogenpolysiloxane (C)(i), at least one hydrosilylation catalyst (C)(ii) and optionally at least one cure inhibitor (C)(iii);
(D) at least one peroxide catalyst.

2. The curable silicone elastomer composition in accordance with claim 1, wherein the composition contains ≤0.1 wt. % of the composition of electrically conductive filler or electrically semi-conductive filler or a mixture thereof.

3. The curable silicone elastomer composition in accordance with claim 1, wherein when component (C) is present in the composition, component (A) contains at least two alkenyl or alkynyl groups per molecule, and when component (D) is the sole catalyst in the composition, the presence of at least two alkenyl or alkynyl groups per molecule in component (A) is optional.

4. The curable silicone elastomer composition in accordance with claim 1, wherein component (B) is at least partially treated with one or more fluorinated hydrophobing treating agents selected from the group of: trifluoropropyltrimethoxysilane and trifluoropropyltriethoxysilane; silanol terminated trifluoropropylalkyl siloxanes having from 2 to 20 siloxane repeating units, where the alkyl groups have 1 to 6 carbons; and bis(trifluoropropyldialkyl)silazanes, where each alkyl group has 1 to 6 carbons; to render component (B) hydrophobic.

5. The curable silicone elastomer composition in accordance with claim 1, wherein component (C)(i) is present and selected from one or more of:
(i) trimethylsiloxy-terminated methylhydrogenpolysiloxanes,
(ii) trimethylsiloxy-terminated polydimethylsiloxane-methylhydrogensiloxanes,
(iii) dimethylhydrogensiloxy-terminated dimethylsiloxane-methylhydrogensiloxane copolymers,
(iv) dimethylsiloxane-methylhydrogensiloxane cyclic copolymers,
(v) copolymers composed of (CH₃)₂HSiO_{1/2} units and SiO_{4/2} units, and
(vi) copolymers composed of (CH₃)₃SiO_{1/2} units, (CH₃)₂HSiO_{1/2} units, and SiO_{4/2} units.

6. The A-curable silicone elastomer composition in accordance with claim 1, further comprising one or more ingredients selected from: thermally conductive fillers, non-conductive fillers, pot life extenders, flame retardants, lubricants, non-reinforcing fillers, pigments, coloring agents, adhesion promoters, chain extenders, silicone polyethers, mold release agents, diluents, solvents, UV light stabilizers, bactericides, wetting agents, heat stabilizers, compression set additives, plasticizers, and mixtures thereof.

7. The curable silicone elastomer composition in accordance with claim 1, wherein the composition is stored in two parts prior to use, a Part A containing components (A), (B) and (C)(ii), and a part B containing components (A), (B), (C)(i) and (C)(iii).

8. A high voltage insulator comprising an elastomeric product of the curable silicone elastomer composition in accordance with claim 1.

9. A high voltage insulator comprising an elastomeric product obtained or obtainable by curing the curable silicone elastomer composition in accordance with claim 1.

10. (canceled)

11. The high voltage insulator in accordance with claim 8, used as an insulator adapted to reduce electrical stress in high voltage direct current (HVDC) applications.

12. The high voltage insulator in accordance with claim 8, used alone or as part of an article or assembly, optionally wherein the article or assembly is a cable accessory, a cable joint or cable termination materials, boots, sleeves, and/or other fittings in high voltage direct current (HVDC) applications.

13. (canceled)

14. (canceled)

15. (canceled)

16. (canceled)

17. A method of preparing the curable silicone elastomer composition in accordance with claim 1, the method comprising:
(i) making a silicone base composition by mixing component (A) with at least one reinforcing silica filler; and
(ii) introducing component (C), or component (D), or a mixture of components (C) and (D), and storing the resulting composition;
wherein when component (C) is present, the composition is stored in two or more parts with components (C)(i) and (C)(ii) being kept in separate parts; and
wherein the at least one reinforcing silica filler is either at least partially treated with a fluorinated hydrophobing treating agent prior to or during step (i).

18. The method in accordance with claim 17, wherein the reinforcing silica filler is treated with treating agent prior to step (i) and all the reinforcing silica filler is treated with a fluorinated hydrophobing treating agent prior to step (i) or alternatively the reinforcing silica filler is partially treated with a fluorinated hydrophobing treating agent prior to step (i) and the remainder is treated with a non-fluorinated treating agent prior to step (i).

19. The method in accordance with claim 17, wherein component (A) is divided into multiple predetermined aliquots with each aliquot being mixed with a predetermined amount of reinforcing silica filler and a fluorinated hydrophobing treating agent or non-fluorinated treating agent in situ such that multiple partial bases are prepared with the reinforcing silica filler being treated in situ and then subsequently the multiple partial bases are mixed together to obtain the final product of step (i).

20. The method in accordance with claim 17, wherein component (A) is mixed with the reinforcing silica filler and the fluorinated hydrophobing treating agent in situ such that the reinforcing silica filler is treated in situ to obtain the final product of step (i).

21. The method in accordance with claim 17, wherein component (A) is mixed with the reinforcing silica filler and a mixture of fluorinated hydrophobing treating agent and non-fluorinated treating agent in situ such that the reinforcing silica filler is treated in situ to obtain the final product of step (i).

22. The method in accordance with claim 17, in which the composition is in two or more parts, and wherein the parts are mixed together in a multi-part mixing system prior to cure.

23. The method in accordance with claim 17, in which the composition is further processed by injection moulding, encapsulation moulding, press moulding, dispenser moulding, extrusion moulding, transfer moulding, press vulcanization, centrifugal casting, calendering, bead application or blow moulding.

24. The method in accordance with claim 17, further defined as a method for the manufacture of a high voltage direct current insulator, wherein the composition is introduced into a mold prior to cure to form a moulded silicone article.

25. The method for the manufacture of a high voltage direct current insulator in accordance with claim 24, wherein the composition is either injection moulded to form an article or overmolded by injection moulding around an article.

26. (canceled)

27. (canceled)

28. (canceled)
